(19) United States
(12) Patent Application Publication
(10) Pub. No.: US 2017/0288885 A1
(43) Pub. Date: Oct. 5, 2017

(54) System, Apparatus And Method For Providing A Physically Unclonable Function (PUF) Based On A Memory Technology

(71) Applicant: Intel Corporation, Santa Clara, CA (US)

(72) Inventors: Amirali Khatib Zadeh, Hillsboro, OR (US); Shekoufeh Qawami, El Dorado Hills, CA (US); Abhranil Maiti, Hillsboro, OR (US)

(21) Appl. No.: 15/086,207

(22) Filed: Mar. 31, 2016

(51) Int. Cl. H04L 9/32; G06F 12/02; G06F 12/14

(52) U.S. Cl. CPC H04L 9/3278; G06F 12/1466; G06F 12/0246; H04L 9/3228; H04L 9/3271; G06F 2212/7201; G06F 2212/1052

(57) ABSTRACT

In one embodiment, an apparatus comprises: a challenger logic to issue a challenge to a responder logic, the challenge including an address of a portion of an array of a non-volatile memory; and the responder logic to receive the challenge and read data from the portion of the array at a read time less than a lockout period and at a demarcation voltage. The challenger logic may be configured to verify the challenge if the read data matches an expected read value, where the expected read value is determined based on configuration parameter information including compensation data associated with the portion of the array. Other embodiments are described and claimed.

### TECHNICAL FIELD

Embodiments relate to enhancing security for integrated circuits.

### BACKGROUND

Manufacturing of integrated circuits (ICs) by a third party to the designer may expose a given design to tampering and unauthorized cloning by the party breaching the intellectual property (IP) logic in the design. IP cloning causes not only revenue losses but also can damage a brand. Traditionally, an IC can generate unique keys for accessing important applications such as IP security and protection mechanisms. These keys are then stored in on-chip non-volatile memory (NVM) that is believed to be impervious to illegal access and duplication. However, it is now known that skillful adversaries employing advanced reverse engineering techniques can access a secret key. As a result, a duplicated IC with the key obtained through reverse engineering cannot be distinguished from a genuine IC.

One technique to protect against such cloning is incorporation of a Physically Unclonable Function (PUF) in an authentic chip. PUFs are security primitives embodied in the hardware structure, and they exploit the physical properties of the chip to generate a unique signature. PUFs operate on the foundation of challenge-response, which functions on the basis of complex and variable physical processes. Typically PUFs require inclusion of dedicated circuitry to perform a set of challenges (c's) to a set of responses (r's) based on intractably complex and random physical factors in silicon. Such added circuitry imposes overhead in design and performance.

### BRIEF DESCRIPTION OF THE DRAWINGS

FIG. 1 is a block diagram of a non-volatile memory in accordance with an embodiment.

FIG. 2 is a graphical illustration of a probability distribution of voltages in accordance with an embodiment of the present invention.

FIG. 3 is a high level flow diagram of an authentication protocol in accordance with an embodiment of the present invention.

FIG. 4 is a flow diagram of a PUF-based integrity process from the view of a challenger in accordance with an embodiment of the present invention.

FIG. 5 is a flow diagram of a PUF-based integrity process from the view of a requester in accordance with an embodiment of the present invention.

FIG. 6 is a block diagram of a portion of a system in accordance with an embodiment.

FIG. 7 is a block diagram of an example system with which embodiments can be used.

FIG. 8 is a block diagram of a system in accordance with another embodiment of the present invention.

FIG. 9 is a block diagram of a system in accordance with another embodiment of the present invention.

FIG. 10 is a block diagram illustration of a memory cell in accordance with an embodiment of the present invention.

### DETAILED DESCRIPTION

In various embodiments, unique properties of a memory technology such as a given non-volatile memory can be leveraged to perform PUF operations without dedicated PUF circuitry. Stated another way, such PUF operations may be thought of as PUF emulation, in that dedicated PUF hardware need not be provided. Embodiments enable generation of a signature that is unique per each physical instance of an IC, and can be used to cost effectively ensure integrity and authenticity of an IC.

Embodiments may be used in connection with advanced memory technologies such as a variety of non-volatile memory technologies including but not limited to phase change memories. The characteristics of the material used in such memory technology can be used for creating a PUF. In embodiments, a Challenge-Response Pair (CRP) can be created, in which the challenge (c) includes: i) memory cell address; ii) time, t, which is a read time at which a memory cell is read after it is written; and iii) demarcation voltage (VDM), which determines threshold between “Set” and “Reset” states. As used herein writing logic ‘1’ to a cell is referred to as a “Set” operation. As used herein writing logic ‘0’ to a cell is referred to as a “Reset” operation.

The response (r) to the challenge (c) is the value of the accessed memory cell. To obtain the r, the memory cell is read during a lockout period (the lockout period is a duration in which a memory cell is not stabilized in its defined state). Stated another way, a read operation is not legal in normal operation until this lockout period has expired. Dependency of the read operation on t and VDM is the fundamental phenomenon underlying signature generation. Each cell is characterized by the parameters specified by properties of the material used by that cell according to various embodiments. To this end, each cell may have configuration parameters associated with it, and which may be stored in a given storage. These parameters are only recognizable internally by the hardware such as a memory controller controlling the memory operation. Therefore, given the parameters under which the cell is read (even under an instable mode), the controller is able to verify whether the value read from the cell while in this undefined state matches with an expected value from that cell. The expected value in this unstable state is a unique signature for the cell.

Embodiments enable enhanced security, as CRPs include, in addition to cell addresses, VDM and t. These extra factors increase the number of CRP sets that can be generated out of one memory cell. With practically unlimited numbers of CRPs, each pair can be used only once. This essentially serves as a time pad, and an adversary cannot predict a challenge to be used for a next authentication event. Embodiments further realize this security with reduced area cost since, unlike delay-based PUFs (e.g., arbiter and ring oscillator), there are no dedicated logic blocks or transistors for generating the CRPs.

Embodiments may leverage existing cells of the memory to perform a given CRP, and thereafter the same cells are also used by the SoC for normal storage or memory purposes. As soon as the system's request for generating a CRP is completed, the allocated memory cells can be released back to the system. This shared hardware resource usage avoids the expense of dedicated PUFs, which remain idle without any further use until the next time the system calls for a CRP. Embodiments can efficiently perform a CRP, as the underlying memory technology has low write/read latency, and can perform the CRP operation within a very small number of clock cycles.

Embodiments thus utilize the instability properties of the memory cells for generating a signature that is unique to each physical instance of an IC. As such, embodiments provide a PUF that exploits the property of material used in the memory technology. This PUF provides a mechanism for generating a unique signature for the IC, which can be used to thwart unauthorized IP modification, and counterfeits.

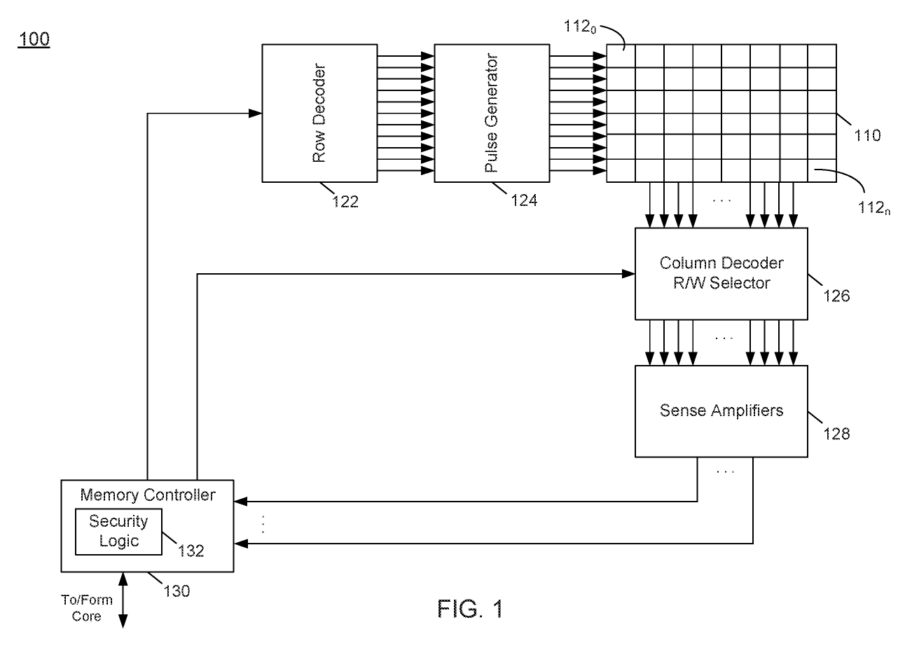

Referring now to FIG. 1, shown is a block diagram of a non-volatile memory in accordance with an embodiment. As shown in FIG. 1, memory 100 may be a given non-volatile memory, which in embodiments may be a phase change-based memory, a 3D memory such as an Intel® 3D XPoint non-volatile memory, static random access memory (SRAM) or so forth. In some embodiments, memory 100 may provide for large storage capabilities in a relatively small area, via a 3D memory array 110. However, the scope of the present invention is not limited in this regard, and embodiments apply equally to many different types of memory structures. As seen, a memory controller 130 is coupled to various components of memory 100. In different embodiments, memory controller 130 may be a co-located memory controller, e.g., within a package (and even the same semiconductor die) as the rest of memory 100. In other cases, memory controller 130 may be an integrated memory controller of a processor or other system-on-chip (SoC). Memory controller 130 includes a security logic 132. Security logic 132 may enable PUF operations using memory 100, without providing for separate PUF circuitry within a system.

In operation, memory controller 130 provides control signals for reading and writing array 110. In various embodiments, array 110 may be configured with a plurality of cells 112₀-112ₙ. These cells may be single-bit storage elements. Or in other cases, each cell 112 may provide for multi-bit storage, e.g., bit width or multi-bit width, including large numbers of bits or bytes. As one such example, each cell 112 may be configured as a 128-bit storage element. In other cases, page-sized cells are possible, among many other variations.

In any event, memory controller 130 provides control signals to a row decoder 122 which in turn provides control signals to a pulse generator 124. Pulse generator 124 provides pulses to selected cells 112 of memory array 110 to perform read and write operations (as well as other memory control operations such as refresh operations and so forth).

As further illustrated, memory controller 130 also provides control signals to a column decoder 126 to perform writes and reads of data to/from memory array 110. For read operations, read data is provided to a set of sense amplifiers 128, which senses a given current present at a memory cell and provides the sensed or read data to memory controller 130. As illustrated, memory controller 130 may be in further communication with various logic, such as one or more cores, which may be a requester of read and write operations.

For purposes of performing PUF-based security operations, security logic 132 may issue challenges to a requester (e.g., internal to security logic 132 itself) to write and read a given one or more cells 112 using one or more parameters outside of legal memory parameters. Based on read data, security logic 132 can determine whether the read data that is returned includes an expected value, given the illegal memory parameter(s). If so, the challenge is successfully completed. Otherwise, the challenge fails, and a given security policy such as preventing access to one or more IP logics of a processor can be initiated.

Unlike other memory technologies that typically operate based on stored charge, operation of memory cells herein depends on bulk properties of the material used between word and bit lines. Every normal write/read operation in a memory cell relies on: a) VSet and VReset, which are required voltages for “Set” and “Reset” operations; b) VDM, which is applied for reading the memory cell; and c) t, which is defined as the time at which a memory cell is read.

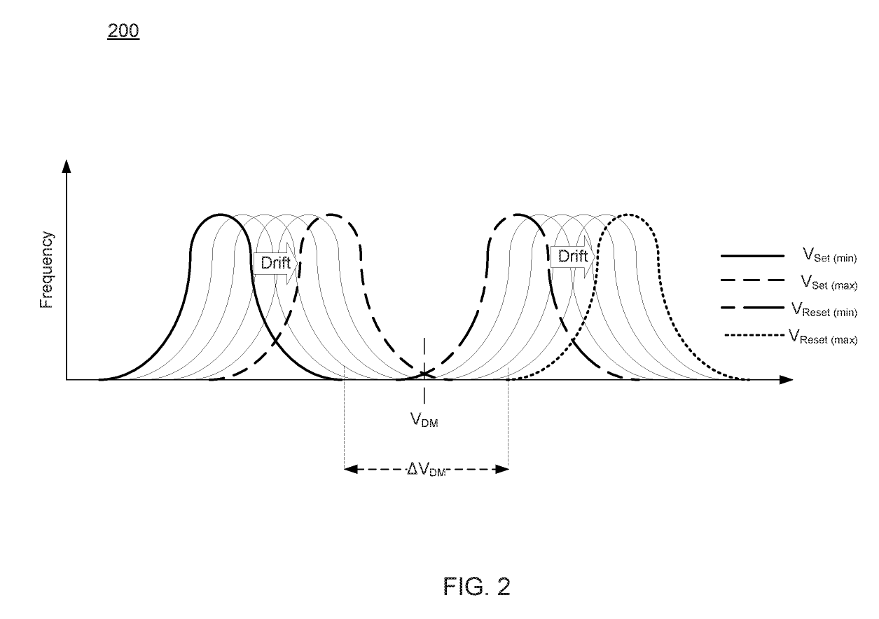

FIG. 2 is a graphical illustration of a probability distribution of voltages in accordance with an embodiment of the present invention. In order to write into a memory cell (changing its internal state to a defined state of ‘1’ or ‘0’), a selected one of VSet and VReset (each of which may be within a given range between a maximum and a minimum) is applied across the cell for a certain time. Note that after VSet and VReset are disconnected from the cell, the memory cell experiences a drift between “Set” and “Reset” states (or vice versa) for a period of time, namely the lockout period. After the lockout period expires, the cell is stable and holds a defined written value. In a normal read operation, a legal VDM is applied across the cell only after the cell exits from the lockout period. The corresponding current (I) to the applied VDM is then sensed by a sense amplifier, and the written value of the accessed cell is read. In addition to t, VDM is affected by a “Drift,” which is a cell-specific phenomenon occurring during the lockout period, as further shown in FIG. 2,

Cell-specific parameters are measured during manufacturing testing/calibration. These parameters characterize a memory cell may be stored as cell configuration parameter information, which may be stored in a compensation data storage of the memory. This compensation data may be used by the hardware for managing write/read operations. If a normal read operation is disturbed by a too early read time (a read time t<tLockout), and/or applying an improper VDM, an unstable bit value is captured and compared against the expected value under the given conditions. The unstable bit value generated in correspondence to a challenge is the response, and it is a unique signature for that specific cell. The conditions under which a signature can be extracted from a memory cell may be formulated as follows in one embodiment: a) t<tLockout; b) VDM (min)<VDM<VDM (max), where tLockout is typically in range of approximately a few microseconds.

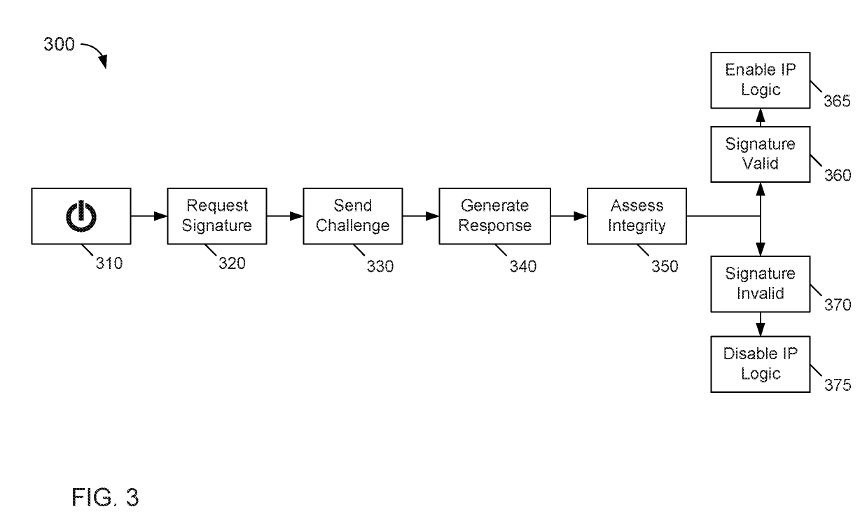

Referring now to FIG. 3, shown is a high level flow diagram of an authentication protocol in accordance with an embodiment of the present invention. As shown in FIG. 3, protocol 300 may be performed on reset of a system including a given non-volatile memory that can perform the PUF operations described herein (block 310). More specifically, upon reset of a system and/or during early boot operations, a request for signature may be issued (block 320). In some embodiments, a basic input/output system (BIOS) may issue this request. In turn, a challenge may be sent (block 330). This challenge including one more randomly generated parameters (one or more of address, VDM and t, where at least one of t and VDM may be outside of a legal range) can be sent by challenger circuitry, which may be implemented in an embodiment using memory controller circuitry either within or associated with the non-volatile memory. In turn, a responder circuit may generate a response (block 340). In an embodiment, this responder circuitry similarly may be implemented within such memory controller.

Upon receipt of the response, e.g., by the challenger circuit, the integrity of the IC may be assessed (block 350). In an embodiment, integrity may be assessed by determining whether the response matches an expected response value. If so, the signature may be determined to be valid (block 360). And accordingly, the given IP logic can be enabled (block 365). Otherwise, if the integrity is not validated, e.g., identifying an invalid signature (block 370), the IP logic may be disabled (block 375). Understand while shown at this high level in the embodiment of FIG. 3, many variations and alternatives are possible.

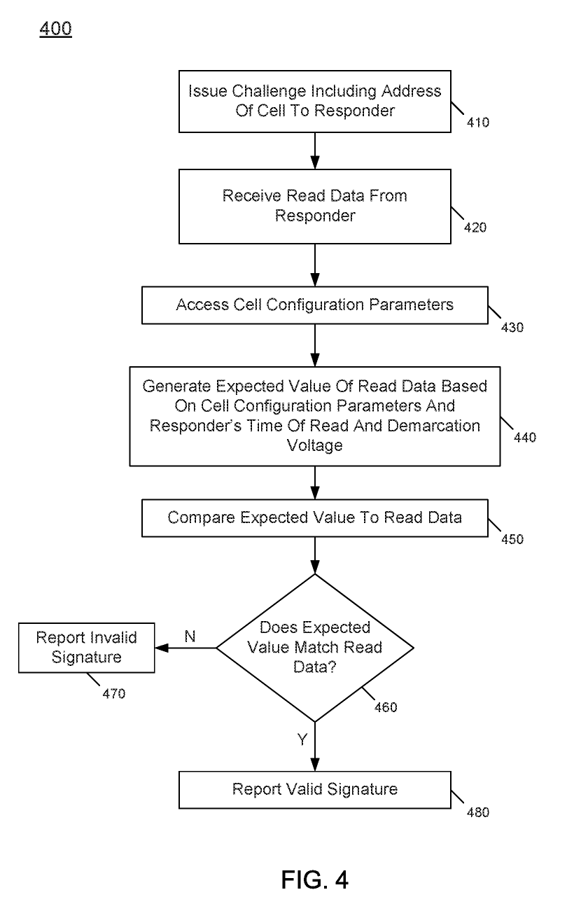

Referring now to FIG. 4, shown is a flow diagram of a PUF-based integrity process from the view of a challenger, in accordance with an embodiment of the present invention. As shown in FIG. 4, method 400 may be performed by a challenger. In various embodiments, such challenger may be implemented as hardware, software, firmware and/or combinations thereof. Understand that in given embodiments, the challenger can be implemented using general-purpose controller circuitry, such that the real estate, power consumption and layout expense of dedicated PUF circuitry can be avoided.

As illustrated, method 400 begins by issuing a challenge to a responder (block 410). More specifically, this challenge may include an address of a particular cell of a memory at which the challenge is to be performed. Understand that in various embodiments, to enable a unique signature to be obtained, this challenge may be issued with parameters for use by the responder to generate the response. In embodiments described herein, these parameters include a read time and a demarcation voltage (at least one of which may be outside of a legal range).

Responsive to this request, the responder may perform a write/read operation to write the indicated cell, and then read the cell using the indicated demarcation voltage at the indicated read time. In turn, the responder sends the read data so that, at block 420 the challenger can receive this read data. Next at block 430 the challenger may access cell configuration parameters. Such parameters may include compensation data associated with the cell, which may be stored in a compensation storage associated with the particular cell.

Then at block 440 the challenger may generate an expected value of the read data based on such cell configuration parameters and the responder's time of read and demarcation voltage used. Next at block 450 the challenger may compare this expected value to the read data received from the responder. Next at diamond 460 it is determined whether these values match. If so, a valid signature is identified and may be reported, e.g., to the original requester of the PUF operation (block 480). As described herein, this requester, e.g., BIOS may thereafter enable the IP logic for normal operation responsive to this valid signature indication. Otherwise, if it is determined at diamond 460 that the values do not match, control passes to block 470 where an invalid signature may be reported. As such, the IP logic may be prevented from normal operation, or otherwise disabled based on a given security policy. Understand while shown at this high level in the embodiment of FIG. 4, many variations and alternatives are possible.

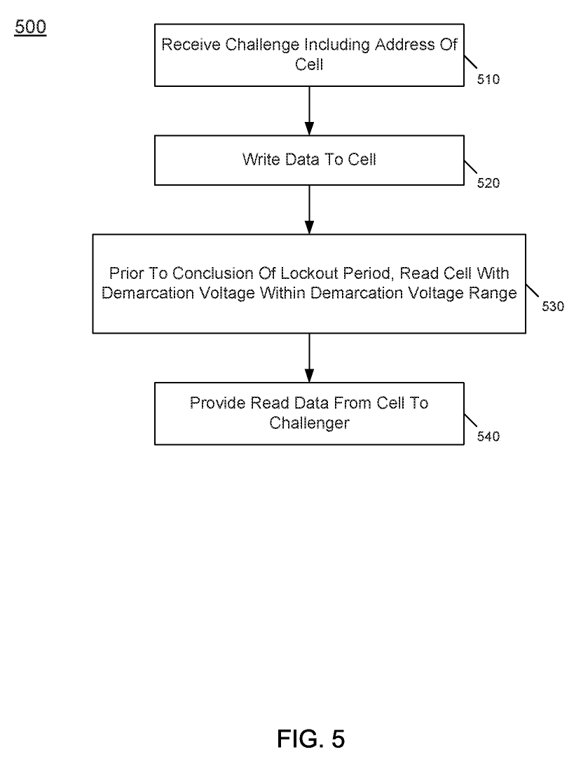

Referring now to FIG. 5, shown is a flow diagram of a method is a flow diagram of a PUF-based integrity process from the view of a challenger in accordance with an embodiment of the present invention. As illustrated, method 500 begins by receiving a challenge in the responder from a challenger (block 510). As shown, this challenge may include an address of the cell for which the PUF operation is to take place. In addition, as described above, this challenge may provide parameters for performing a write/read cycle for the PUF operation, namely a read time and a demarcation voltage.

Responsive to this challenge, at block 520 the responder may write data to the indicated cell. Note that the value of the data written can be predetermined value. As one example, the written data may correspond to a N-bit data value having predetermined value, e.g., approximately equal numbers of logic 0 and logic 1 values randomly distributed within the data. Next, at block 530 the cell may be read. More specifically, this cell may be read at an illegal time within the lockout period, namely the read time indicated by the challenger. Furthermore, the information is read with a given demarcation voltage, as indicated by the challenger. Understand that this demarcation voltage may be a randomly determined value within a range of legal demarcation voltage values. Next at block 540 this read data is provided to the challenger for integrity verification.

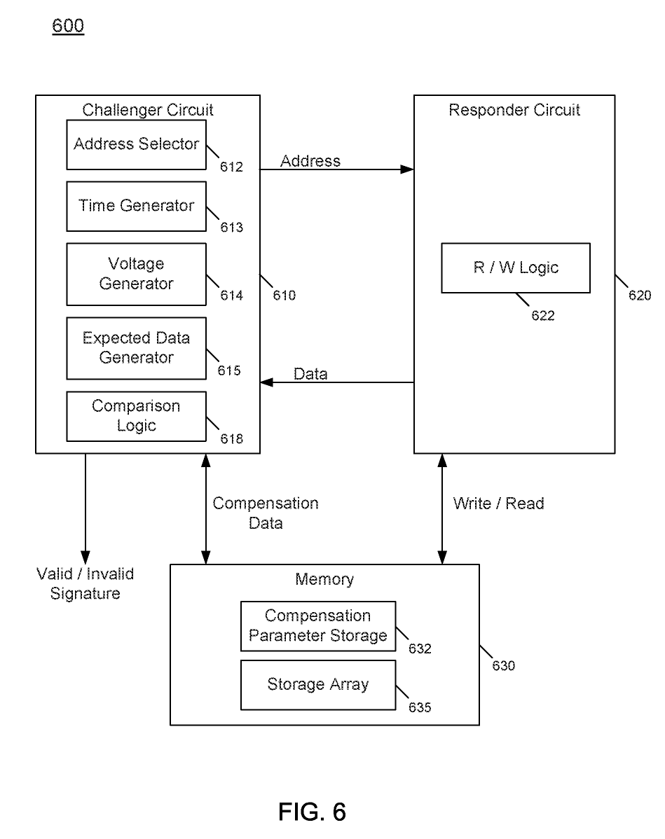

Referring now to FIG. 6, shown is a block diagram of a portion of a system in accordance with an embodiment. As shown in FIG. 6, system 600 may be a portion of a given computing device. As examples, assume that the computing device is one of a server computer, desktop computer, laptop computer, tablet computer, smart phone or any other such computing device. At a high level, system 600 includes a challenger circuit 610, a responder circuit 620, and a memory 630. Memory 630 may be a given non-volatile memory, such as a phase change memory or other advanced memory technology. Memory 630 includes a storage array 635 which may include a large number of individual memory cells, each of which can store one or more bits of information. In addition, memory 630 includes a compensation parameter storage 632. In various embodiments, compensation parameter storage 632 may be configured to store configuration parameters for compensation data associated with the cells of storage array 635. As such, each cell or group of cells may be associated with compensation parameter information stored in storage 632, including compensation to be applied for given read times and/or demarcation voltages, among other potential memory read/write parameters. For example, if a read is issued to a cell that has been recently written without waiting for the lockout time, a few reset bits could be read as set bits, or vice versa. The compensation performed as described herein, as an example, may be to add or subtract some amount of voltage (e.g., a few 100 millivolts) to VDM based on location of cell, for example, after factory setting compensation.

In different embodiments, challenger circuit 610 and responder circuit 620 may be implemented as part of memory controller circuitry. As one example, such memory controller circuitry may be implemented internally to memory 630. In other cases, the memory controller circuitry may be a standalone memory controller, or a memory controller integrated within a processor or other SoC. In a particular embodiment, a SoC or other processor may include one or more semiconductor dies. In one example, memory 630 may be integrated on a first semiconductor die to provide a phase change or other advanced memory technology. In turn, memory controller circuitry including challenger circuit 610 and responder circuit 620 may be implemented on a second semiconductor die, e.g., a complementary metal oxide semiconductor (CMOS) die. In other cases, all the circuitry shown in FIG. 6 can be implemented on one semiconductor die. Also understand that challenger circuit 610 and responder circuit 620 may be implemented by general purpose memory controller circuitry so that the expense of dedicated circuitry for PUF operations can be avoided.

As illustrated, challenger circuit 610 includes an address selector 612, which may be configured to randomly select a given cell within storage array 635 for use in a particular PUF operation. In addition, challenger circuit 610 may include a time generator 613 and a voltage generator 614, which may randomly determine a corresponding read time and demarcation voltage for use in a given PUF operation. Note that the read time may be an illegal read time (namely within the lockout period), while the demarcation voltage may be within a legal range of demarcation voltages. This information may be provided by way of a challenge to responder circuit 620. In turn, responder circuit 620 may include a read/write logic 622 which may be configured to perform a write operation to the indicated cell, and thereafter at the given read time and demarcation voltage, perform a read operation, and send the read data back to challenger circuit 610.

Challenger circuit 610, via an expected data generator 615, may generate expected data for the given challenge, e.g., based on information stored in compensation parameter storage 632. Comparison logic 618 of challenger circuit 610 may in turn perform a comparison between this expected data and the read data received from responder circuit 620. Depending on whether a match occurs (which may require a complete match, in certain embodiments (or at least a threshold level in other embodiments)), challenger circuit 610 may indicate whether a valid or invalid signature is identified. Challenger circuit 610 thus may issue a signature report to a requester, e.g., BIOS. Understand while shown at this high level in the embodiment of FIG. 6, many variations and alternatives are possible.

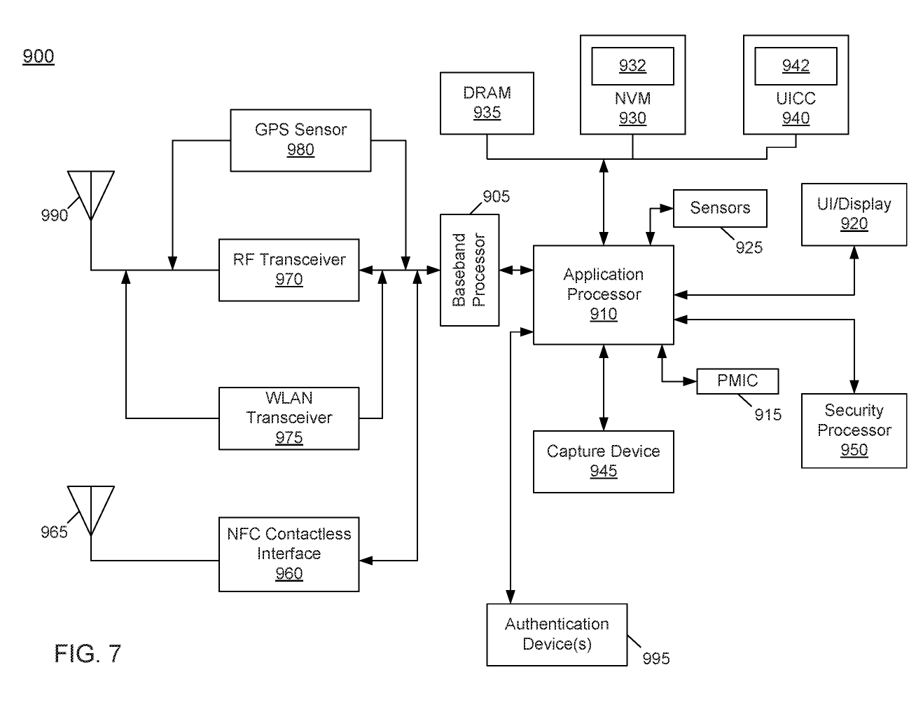

Referring now to FIG. 7, shown is a block diagram of an example system with which embodiments can be used. As seen, system 900 may be a smartphone or other wireless communicator or any other IoT device. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory 930, which in an embodiment may be a three-dimensional stacked phase change memory, and a system memory, namely a DRAM 935. In some embodiments, non-volatile memory 930 may include security circuitry 932 as described herein to perform PUF-based challenges leveraging aspects of the memory itself. As further seen, application processor 910 also couples to a capture device 945 such as one or more image capture devices that can record video and/or still images.

Still referring to FIG. 7, a universal integrated circuit card (UICC) 940 comprises a subscriber identity module, which in some embodiments includes a secure storage 942 to store secure user information. System 900 may further include a security processor 950 that may that may implement a trusted execution environment (TEE), and which may couple to application processor 910. Furthermore, application processor 910 may implement a secure mode of operation, such as Intel® Software Guard Extensions (SGX) to a given instruction set architecture, and circuitry for hosting of a TEE. A plurality of sensors 925, including one or more multi-axis accelerometers may couple to application processor 910 to enable input of a variety of sensed information such as motion and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 7, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received such as in one or more IoT networks, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein when context information is to be used in a pairing process. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

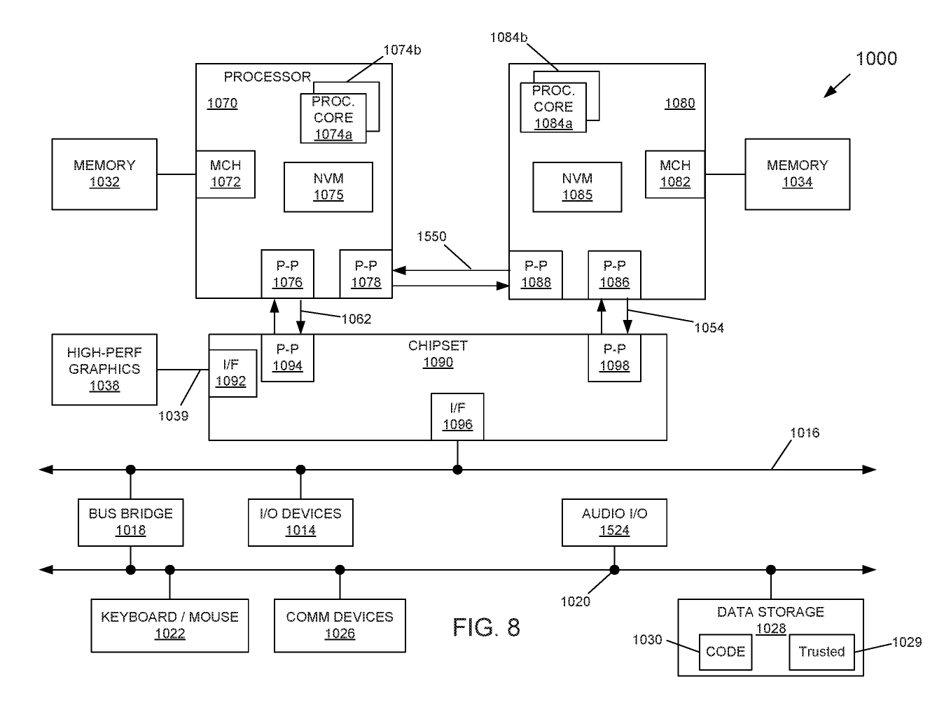

Referring now to FIG. 8, shown is a block diagram of a system in accordance with another embodiment of the present invention. As shown in FIG. 8, multiprocessor system 1000 is a point-to-point interconnect system such as a server system, and includes a first processor 1070 and a second processor 1080 coupled via a point-to-point interconnect 1050. As shown in FIG. 8, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include an integrated non-volatile memory 1075 and 1085, which may be adapted on the same or different die as the remainder of the circuitry of the processor. This non-volatile memory may be used to perform PUF-based security operations as described herein.

Still referring to FIG. 8, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 8, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 8, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 8, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device. As seen, data storage unit 1028 may include code 1030, in one embodiment. As further seen, data storage unit 1028 also includes a trusted storage 1029 to store sensitive information to be protected. Further, an audio I/O 1024 may be coupled to second bus 1020.

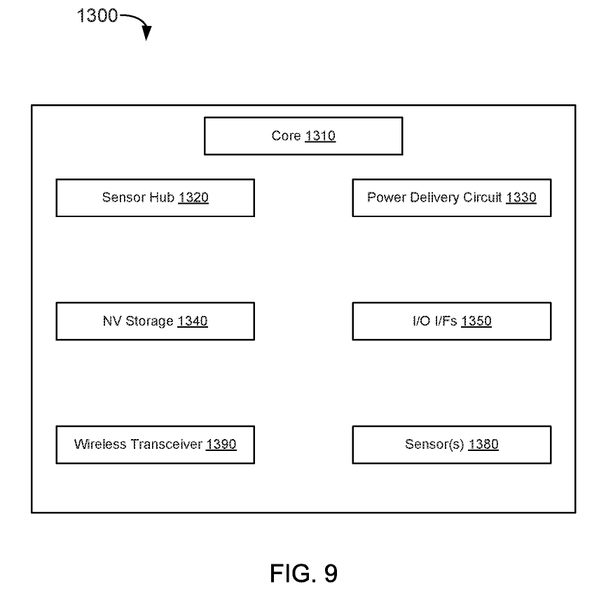

Embodiments may be used in environments where IoT devices may include wearable devices or other small form factor IoT devices. Referring now to FIG. 9, shown is a block diagram of a wearable module 1300 in accordance with another embodiment. In one particular implementation, module 1300 may be an Intel® Curie™ module that includes multiple components adapted within a single small module that can be implemented as all or part of a wearable device. As seen, module 1300 includes a core 1310 (of course in other embodiments more than one core may be present). Such core may be a relatively low complexity in-order core, such as based on an Intel Architecture® Quark™ design. In some embodiments, core 1310 may implement a TEE as described herein. Core 1310 couples to various components including a sensor hub 1320, which may be configured to interact with a plurality of sensors 1380, such as one or more biometric, motion environmental or other sensors. A power delivery circuit 1330 is present, along with a non-volatile storage 1340, which may include integrated memory controller circuitry to perform PUF-based challenges as described herein. In an embodiment, this circuit may include a rechargeable battery and a recharging circuit, which may in one embodiment receive charging power wirelessly. One or more input/output (IO) interfaces 1350, such as one or more interfaces compatible with one or more of USB/SPI/I²C/GPIO protocols, may be present. In addition, a wireless transceiver 1390, which may be a Bluetooth™ low energy or other short-range wireless transceiver is present to enable wireless communications as described herein. Understand that in different implementations a wearable module can take many other forms. Wearable and/or IoT devices have, in comparison with a typical general purpose CPU or a GPU, a small form factor, low power requirements, limited instruction sets, relatively slow computation throughput, or any of the above.

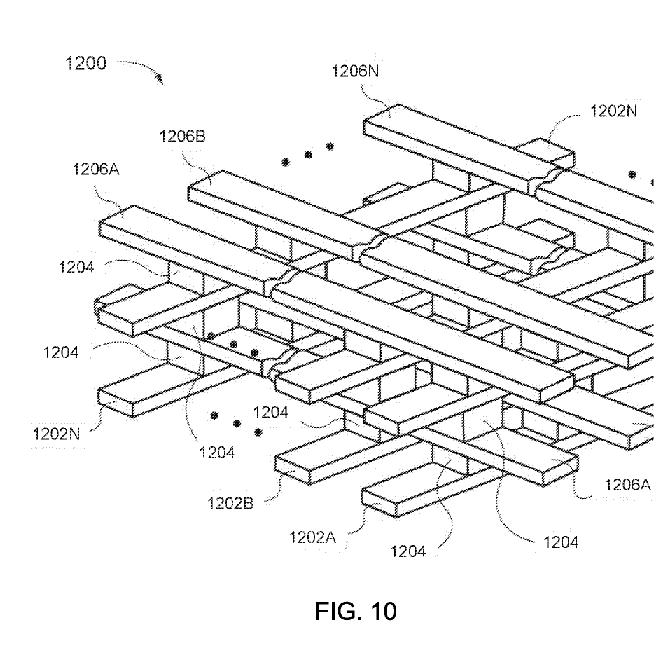

Referring now to FIG. 10, shown is a block diagram illustration of a memory cell in accordance with an embodiment of the present invention. In some examples, a memory array 1200 includes a first number of word lines 1202A, 1202B, . . . , 1202N (collectively referred to as word lines 1202) and a first number of bit lines 1206A, 1206B, . . . , 1206N (collectively referred to as bit lines 1206). As shown in FIG. 10, the word lines 1202 may be arranged parallel to one another. Bit lines 1206 can be arranged parallel to one another and orthogonal to word lines 1202. Word lines 1202 and bit lines 1206 can be made from a conductive material, such as copper, tungsten, titanium, aluminum, etc. Layers or decks of word lines and bit lines can be stacked to create a 3D lattice structure. As shown in FIG. 10, layers of word lines 1202 alternate with layers of bit lines 1206 to form a 3D structure. Memory array 1200 includes a plurality of memory cells 1204. In one embodiment, memory cells 1204 can be implemented as Intel® 3D XPoint memory cells. Each memory cell 1204 is connected to a word line (e.g., word line 1202A) and a bit line (e.g., bit line 1206A). By connecting each memory cell to a single word line and a single bit line in a 3D cross-point array, each memory cell 1204 is individually accessible by specifying a word line and a bit line, for example, by a memory address. A subset of memory cells 1204 can be designated to store a parameter table which may include a plurality of bins defined by ranges of write operations and various parameters related to write operations performed on memory array 1200. In embodiments, this parameter table may be access in performing PUF-based challenges as described herein.

The following Examples pertain to further embodiments.

In Example 1, an apparatus comprises: a challenger logic to issue a challenge to a responder logic, the challenge including an address of a portion of an array of a non-volatile memory; and the responder logic to receive the challenge and read data from the portion of the array at a read time less than a lockout period and at a demarcation voltage. The challenger logic may be configured to verify the challenge if the read data matches an expected read value, where the challenger logic to determine the expected read value based on configuration parameter information including compensation data associated with the portion of the array.

In Example 2, the responder logic of Example 1 is to write the data to the portion of the array responsive to the challenge and read the data from the portion of the array prior to completion of the lockout period following the write.

In Example 3, the challenger logic is to indicate the read time and the demarcation voltage to the responder logic, where at least one of the demarcation voltage and the read time is randomly determined by the challenger logic.

In Example 4, the challenge comprises a one time password.

In Example 5, the non-volatile memory of one or more of the above Examples comprises a phase change memory.

In Example 6, the read data comprises a multi-bit value.

In Example 7, the challenger logic of Example 6 is to verify the challenge if the multi-bit value of the read data matches a multi-bit value of the expected read value to at least a threshold level.

In Example 8, the read data differs from a stored value in the portion of the array, after the lockout period has completed.

In Example 9, the apparatus of one or more of the above Examples further comprises a memory controller including the challenger logic and the responder logic, the challenger logic and the responder logic comprising general-purpose circuitry of the memory controller.

In Example 10, the apparatus of one or more of the above Examples comprises a SoC that includes the non-volatile memory and the memory controller.

In Example 11, the SoC of Example 10 comprises a first semiconductor die including the non-volatile memory and a second semiconductor die including the memory controller.

In Example 12, the SoC of one of the above Examples comprises a security logic to request the challenge after a reset, and where the security logic is to prevent normal operation of the SoC if the challenger logic does not verify the challenge.

In Example 13, a method comprises: issuing a challenge to a responder, the challenge including an address of a cell of a non-volatile memory and associated with a read time and a demarcation voltage, where at least one of the read time and the demarcation voltage is outside a legal range; identifying a read value obtained from the responder, responsive to the challenge; generating an expected value for the read value based at least in part on configuration parameter information associated with the cell; and reporting a result of the challenge based at least in part on a comparison between the read value and the expected value.

In Example 14, the method further comprises accessing the cell configuration parameter information from a compensation table stored in the non-volatile memory.

In Example 15, the method further comprises communicating the read time and the demarcation voltage to the responder, where at least one of the read time and the demarcation voltage comprises a randomly generated value.

In Example 16, the method further comprises communicating the read time having a value less than a lockout period associated with the non-volatile memory.

In Example 17, the method further comprises reporting the result to a security logic of a system, the security logic to enable the system responsive to a valid signature indicated by the report and disable the system responsive to an invalid signature indicated by the report.

In another example, a computer readable medium including instructions is to perform the method of any of the above Examples.

In another example, a computer readable medium including data is to be used by at least one machine to fabricate at least one integrated circuit to perform the method of any one of the above Examples.

In another example, an apparatus comprises means for performing the method of any one of the above Examples.

In Example 18, a SoC comprises: a non-volatile memory including a plurality of cells, at least some the plurality of cells to store compensation data for the non-volatile memory; and a memory controller to couple to the non-volatile memory. The memory controller may comprise: a first logic to issue a challenge including an address of a cell of the plurality of cells, the challenge associated with a read time and a demarcation voltage, where at least one of the read time and the demarcation voltage is outside of a legal range; and a second logic, responsive to the challenge, to read data from the cell at the read time and the demarcation voltage, where the first logic is to verify the challenge if the read data matches an expected read value, the expected read value based on the compensation data associated with the cell.

In Example 20, the second logic is to read the data from the cell prior to completion of a lockout period following a write to the cell, the read time within the lockout period.

In Example 21, the first logic is to randomly generate at least one of the read time and the demarcation voltage, to enable the challenge to emulate a physically unclonable function.

In Example 22, an apparatus comprises: challenger means for issuing a challenge to a responder means, the challenge including an address of a portion of an array of a non-volatile memory; and the responder means for receiving the challenge and read data from the portion of the array at a read time less than a lockout period and at a demarcation voltage. The challenger means may be configured for verifying the challenge if the read data matches an expected read value and for determining the expected read value based on configuration parameter information including compensation data associated with the portion of the array.

In Example 23, the responder means is to write the data to the portion of the array responsive to the challenge and read the data from the portion of the array prior to completion of the lockout period following the write.

In Example 24, the challenger means is to indicate the read time and the demarcation voltage to the responder means, where at least one of the demarcation voltage and the read time is randomly determined by the challenger means.

Understand that various combinations of the above Examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a challenger logic to issue a challenge to a responder logic, the challenge including an address of a portion of an array of a non-volatile memory; and
the responder logic to receive the challenge and read data from the portion of the array at a read time less than a lockout period and at a demarcation voltage;
wherein the challenger logic is to verify the challenge if the read data matches an expected read value, the challenger logic to determine the expected read value based on configuration parameter information including compensation data associated with the portion of the array.

2. The apparatus of claim 1, wherein the responder logic is to write the data to the portion of the array responsive to the challenge and read the data from the portion of the array prior to completion of the lockout period following the write.

3. The apparatus of claim 1, wherein the challenger logic is to indicate the read time and the demarcation voltage to the responder logic, wherein at least one of the demarcation voltage and the read time is randomly determined by the challenger logic.

4. The apparatus of claim 1, wherein the challenge comprises a one time password.

5. The apparatus of claim 1, wherein the non-volatile memory comprises a phase change memory.

6. The apparatus of claim 1, wherein the read data comprises a multi-bit value.

7. The apparatus of claim 6, wherein the challenger logic is to verify the challenge if the multi-bit value of the read data matches a multi-bit value of the expected read value to at least a threshold level.

8. The apparatus of claim 1, wherein the read data differs from a stored value in the portion of the array, after the lockout period has completed.

9. The apparatus of claim 1, further comprising a memory controller including the challenger logic and the responder logic, the challenger logic and the responder logic comprising general-purpose circuitry of the memory controller.

10. The apparatus of claim 9, wherein the apparatus comprises a system on chip (SoC), the SoC including the non-volatile memory and the memory controller.

11. The apparatus of claim 10, wherein the SoC comprises a first semiconductor die including the non-volatile memory and a second semiconductor die including the memory controller.

12. The apparatus of claim 9, wherein the SoC comprises a security logic to request the challenge after a reset, and wherein the security logic is to prevent normal operation of the SoC if the challenger logic does not verify the challenge.

13. At least one computer readable storage medium comprising instructions that when executed enable a system to:
issue a challenge to a responder, the challenge including an address of a cell of a non-volatile memory and associated with a read time and a demarcation voltage, wherein at least one of the read time and the demarcation voltage is outside a legal range;
identify a read value obtained from the responder, responsive to the challenge;
generate an expected value for the read value based at least in part on configuration parameter information associated with the cell; and
report a result of the challenge based at least in part on a comparison between the read value and the expected value.

14. The at least one computer readable storage medium of claim 13, further comprising instructions that when executed enable the system to access the cell configuration parameter information from a compensation table stored in the non-volatile memory.

15. The at least one computer readable storage medium of claim 13, further comprising instructions that when executed enable the system to communicate the read time and the demarcation voltage to the responder, wherein at least one of the read time and the demarcation voltage comprises a randomly generated value.

16. The at least one computer readable storage medium of claim 15, further comprising instructions that when executed enable the system to communicate the read time having a value less than a lockout period associated with the non-volatile memory.

17. The at least one computer readable storage medium of claim 13, further comprising instructions that when executed enable the system to report the result to a security logic of the system, the security logic to enable the system responsive to a valid signature indicated by the report and disable the system responsive to an invalid signature indicated by the report.

18. A system on chip (SoC) comprising:
a non-volatile memory including a plurality of cells, at least some the plurality of cells to store compensation data for the non-volatile memory; and
a memory controller to couple to the non-volatile memory, the memory controller comprising:
a first logic to issue a challenge including an address of a cell of the plurality of cells, the challenge associated with a read time and a demarcation voltage, wherein at least one of the read time and the demarcation voltage is outside of a legal range; and
a second logic, responsive to the challenge, to read data from the cell at the read time and the demarcation voltage, wherein the first logic is to verify the challenge if the read data matches an expected read value, the expected read value based on the compensation data associated with the cell.

19. The SoC of claim 18, wherein the second logic is to read the data from the cell prior to completion of a lockout period following a write to the cell, the read time within the lockout period.

20. The SoC of claim 18, wherein the first logic is to randomly generate at least one of the read time and the demarcation voltage, to enable the challenge to emulate a physically unclonable function.
